(19) United States
(12) Patent Application Publication
(10) Pub. No.: US 2024/0064600 A1
(43) Pub. Date: Feb. 22, 2024

(54) HANDOVER PROCESSING METHOD, TERMINAL, AND STORAGE MEDIUM

(71) Applicant: SPREADTRUM COMMUNICATIONS (SHANGHAI) CO., LTD., Shanghai (CN)

(72) Inventors: Yun DENG, Shanghai (CN); Xiangxin GU, Shanghai (CN); Hualei WANG, Shanghai (CN)

(21) Appl. No.: 18/260,397

(22) PCT Filed: Jan. 28, 2022
(86) PCT No.: PCT/CN2022/074557

§ 371 Date: Jul. 5, 2023

(30) Foreign Application Priority Data
Jan. 6, 2021 (CN) 202110017001.7

(51) Int. Cl. H04W 36/36; H04W 36/30; H04W 36/00

(52) U.S. Cl. CPC H04W 36/362; H04W 36/30; H04W 36/008357; H04W 36/0055

(57) ABSTRACT

A handover processing method, a terminal, and a storage medium are provided. The method includes the following. The terminal acquires at least one handover command, the at least one handover command including at least one of a first handover command, a second handover command, and a conditional handover command, where the first handover command is indicated through layer 1 or layer 2 signaling and the second handover command being indicated through layer 3 signaling. The terminal determines, according to the at least one handover command, a handover command to be preferentially executed. The terminal performs cell handover according to the handover command to be preferentially executed.

### CROSS-REFERENCE TO RELATED APPLICATION(S)

This application is a National Stage of International Application No. PCT/CN2022/074557, field Jan. 28, 2022, which claims priority to Chinese Patent Application No. 2021100170017, filed Jan. 6, 2021, the entire disclosures of which are hereby incorporated by reference.

### TECHNICAL FIELD

This disclosure relates to the field of communication technology, and particularly to a handover processing method and apparatus, a terminal, a network device, and a storage medium.

### BACKGROUND

In a wireless communication system, a terminal using a network service may suffer interruption or quality degradation of the current network service due to factors such as mobility requirements, load adjustment of wireless transmission service, activation operation and maintenance, equipment failure, and cell load.

In order to ensure the continuity and quality of the network service, relevant handover procedures are standardized in protocols developed by the 3rd generation partnership project (3GPP), such as radio resource control (RRC) layer handover procedures and conditional handover (CHO) procedures, so that a communication link of a terminal is transferred from a serving cell (a source base station) to a target cell (a target base station). However, with the continuous evolution and subdivision of communication scenarios, the content of handover processing in the protocols developed by 3GPP needs to be further studied.

### SUMMARY

In a first aspect, a handover processing method is provided in implementations of the disclosure. The method includes the following. A terminal acquires at least one handover command. The at least one handover command includes at least one of a first handover command, a second handover command, and a conditional handover (CHO) command, the first handover command is indicated through layer 1 signaling or layer 2 signaling, and the second handover command is indicated through layer 3 signaling. The terminal determines a handover command to be preferentially executed according to the at least one handover command. The terminal performs cell handover according to the handover command to be preferentially executed.

In a second aspect, a terminal is provided in implementations of the disclosure. The terminal includes a processor, a memory, a communication interface, and one or more programs, where the one or more programs are stored in the memory and configured to be executed by the processor, and the one or more programs include instructions for executing steps in the first aspect of implementations of the disclosure.

In a third aspect, a non-transitory computer-readable storage medium is provided in implementations of the disclosure. The computer-readable storage medium is configured to store a computer program for electronic data interchange (EDI), where the computer program enables a computer to execute part or all of steps described in the first aspect or the second aspect of implementations of the disclosure.

### BRIEF DESCRIPTION OF THE DRAWINGS

In order for clarity in elaboration of technical solutions of implementations of the disclosure, the following will give a brief introduction to the accompanying drawings used for describing the implementations or the available technology. Apparently, the accompanying drawings described below are only some implementations of the disclosure. Based on these drawings, those of ordinary skill in the art can also obtain other drawings without creative effort.

FIG. 1 is a schematic architectural diagram of a wireless communication system provided in implementations of the disclosure.

FIG. 2 is a schematic flowchart of an Xn-based handover procedure provided in implementations of the disclosure.

FIG. 3 is a schematic flowchart of conditional handover provided in implementations of the disclosure.

FIG. 4 is a schematic architectural diagram of a wireless access network provided in implementations of the disclosure.

FIG. 5 is a schematic flowchart of a handover processing method provided in implementations of the disclosure.

FIG. 6 is a schematic flowchart of another handover processing method provided in implementations of the disclosure.

FIG. 7 is a block diagram of functional units of a handover processing apparatus provided in implementations of the disclosure.

FIG. 8 is a block diagram of functional units of another handover processing apparatus provided in implementations of the disclosure.

FIG. 9 is a schematic structural diagram of a terminal provided in implementations of the disclosure.

FIG. 10 is a schematic structural diagram of a network device provided in implementations of the disclosure.

### DETAILED DESCRIPTION

The following will describe technical solutions of implementations of the disclosure with reference to the accompanying drawings in implementations of the disclosure. Apparently, implementations described herein are merely some implementations, rather than all implementations, of the disclosure. Based on the implementations of the disclosure, all other implementations obtained by those of ordinary skill in the art without creative effort shall fall within the protection scope of the disclosure.

Technical solutions of implementations of the disclosure are applicable to various wireless communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi), a 5th generation (5G) system, or other communication systems.

It should be noted that, a conventional wireless communication system supports a limited quantity of connections and therefore is easy to implement. However, with development of communication technology, a wireless communication system will not only support the conventional wireless communication system but also support, for example, device to device (D2D) communication, machine to machine (M2M) communication, machine type communication (MTC), vehicle to vehicle (V2V) communication, vehicle to everything (V2X) communication, or narrow band internet of things (NB-IoT) communication, etc. Therefore, technical solutions of implementations of the disclosure can also be applied to the above wireless communication systems.

Optionally, a wireless communication system in implementations of the disclosure may be applied to a beamforming, a carrier aggregation (CA), a dual connectivity (DC), or a standalone (SA) deployment scenario, etc.

Optionally, the wireless communication system in implementations of the disclosure is applicable to an unlicensed spectrum, and an unlicensed spectrum may be regarded as a shared spectrum. Or the wireless communication system in implementations of the disclosure is applicable to a licensed spectrum, and a licensed spectrum may be regarded as a non-shared spectrum.

Since various implementations are described in connection with a terminal and a network device in implementations of the disclosure, the terminal and the network device involved will be described in detail below.

Specifically, the terminal may be a user equipment (UE), an access terminal, a subscriber unit, a subscriber station, a mobile station, a remote station, a remote terminal, a mobile device, a user terminal, a smart terminal, a wireless communication device, a user agent, or a user device, etc. The terminal may also be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, a trunk equipment, an in-vehicle device, a wearable device, and a terminal in a next-generation communication system, for example, a terminal in an NR network, or a terminal in a future evolved public land mobile network (PLMN), etc. There is no limitation on the terminal in implementations of the disclosure.

Further, the terminal can be deployed on land, which includes indoor or outdoor, handheld, wearable, or in-vehicle. The terminal can be deployed on water (such as ships, etc.). The terminal can also be deployed in the air (such as airplanes, balloons, satellites, etc.).

Further, the terminal may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

Specifically, the network device may be a device configured to communicate with a terminal, and the network device may be a base transceiver station (BTS) in a GSM or a CDMA communication system, a node B (NB) in a WCDMA communication system, an evolutional node B (eNB or eNodeB) in an LTE communication system, and a next generation evolved node B (ng-eNB) in an NR communication system, a next generation node B (gNB) in an NR communication system, or other devices in a core network (CN), such as an access and mobility management function (AMF), a user plan function (UPF), etc. In addition, the network device may also be an access point (AP) in a WLAN, a relay station, a network device in a future evolved PLMN, or a network device in an NTN, etc.

It should be noted that, in some network deployments, the network device may be an independent node for implementing all functions of the above base station. The network device may include a centralized unit (CU) and distributed units (DU), such as a gNB-CU and a gNB-DU, and may also include an active antenna unit (AAU). The CU may implement part of functions of the network device, and the DU may implement part of functions of the network device. For example, the CU is responsible for non-real-time protocols and services, and implements functions of a radio resource control (RRC) layer, a service data adaptation protocol (SDAP) layer, and a packet data convergence protocol (PDCP) layer. The DU is responsible for physical layer protocols and real-time services, and implements functions of a radio link control (RLC) layer, a medium access control (MAC) layer, and a physical (PHY) layer. In addition, the AAU implements part of functions of PHY layer processing, radio-frequency (RF) processing, and relevant functions of the AAU. Since the RRC layer information eventually becomes the PHY layer information or be transformed from the PHY layer information, in the network deployment, the high-layer signaling (such as RRC layer signaling) can be considered to be sent by the DU, or sent by the DU and the AAU. It can be understood that the network device may include at least one of the CU, the DU, and the AAU. Furthermore, the CU may be classified into a network device in a radio access network (RAN), and may also be classified into a network device in the CN, which is not limited here.

Further, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

Further, the network device can provide services for a cell, and a terminal in the cell may communicate with the network device via a transmission resource (for example, a spectrum resource) for the cell. The cell may be a small cell, a metro cell, a micro cell, a pico cell, a femto cell, and the like.

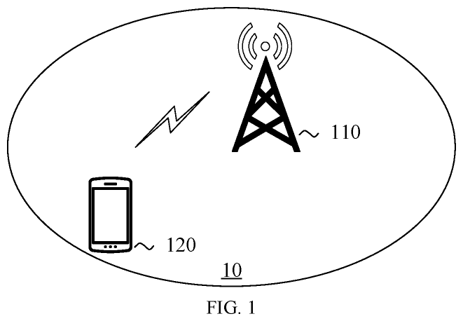

Exemplarily, FIG. 1 illustrates a wireless communication system 10 to which implementations of the disclosure are applied. The wireless communication system 10 may include a network device 110 and a terminal 120. The network device 110 may be a device that can communicate with the terminal 120. The network device 110 can also provide a communication coverage for a specific geographical area and communicate with the terminal 120 in the coverage area.

Optionally, the wireless communication system 10 may further include multiple network devices, and there can be other number of terminals in the coverage area of each of the network devices. There is no limitation in this regard.

Optionally, the wireless communication system 10 may further include other network entities such as a network controller and a mobility management entity. There is no limitation in this regard.

Optionally, in the wireless communication system 10, communication between the network device and the terminal, and communication between terminals may be wireless communication or wire communication. There is no limitation in this regard.

Before a handover processing method provided in implementations of the disclosure is described in detail, the following will give an introduction to communication technologies involved in implementations of the disclosure.

1. Handover Procedure

In a wireless communication system, a terminal using a network service may suffer interruption or quality degradation of the current network service due to factors such as mobility requirements, load adjustment of wireless transmission service, activation operation and maintenance, equipment failure, and cell load. Therefore, in order to ensure the continuity and quality of the network service, the wireless communication system needs to transfer the communication link of the terminal from a serving cell (a source base station) to a target cell (a target base station), that is, performing a handover procedure.

Specifically, the network device can send a handover command (namely, RRC signaling) to the terminal so that the terminal accesses the target cell (the target base station) from the serving cell (the source base station). After receiving the handover command, the terminal accesses the target cell according to target cell information contained in the handover command. In this case, the handover procedure is referred to as layer 3 handover in implementations of the disclosure, which is described as follows by taking an Xn-based handover procedure as an example.

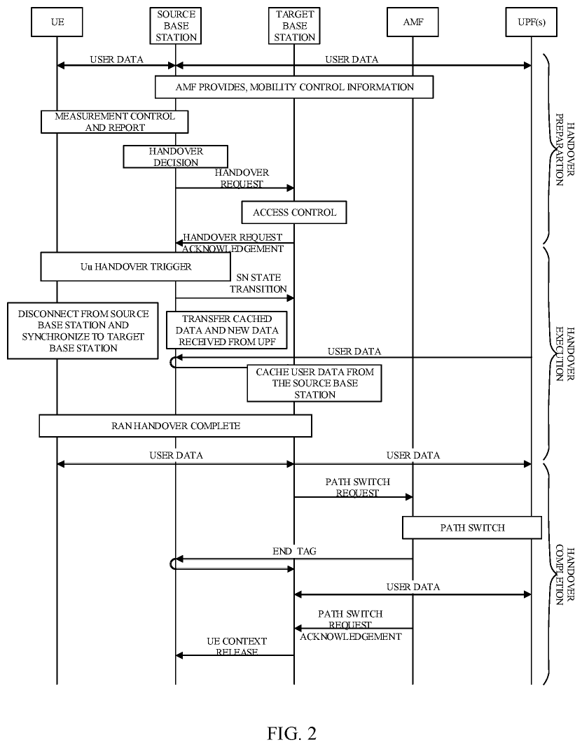

Referring to FIG. 2, the Xn-based handover procedure is divided into the following three phases.

(1) Handover preparation: including transmissions of signaling such as measurement control and report, handover request, and handover request acknowledgement. A handover acknowledgement message contains a handover command generated by the target base station, and the source base station may directly forward the handover command to the terminal without any modification of the handover command generated by the target base station.

(2) Handover execution: the terminal performs handover immediately after receiving the handover command, which includes: the terminal disconnecting from the source base station, synchronizing to the target base station (for example, performing a random access procedure, sending an RRC handover complete message to a second network device, etc.), sequence number (SN) state transition, data forwarding, etc.

(3) Handover completion: the target base station performs a path switch with an AMF and a UPF to change a network path, and releases UE context at the source base station.

2. Conditional Handover (CHO) Procedure

The biggest difference between the CHO procedure and the foregoing handover procedure is that a serving cell (a source base station) can first configure, for a terminal, configuration parameters for one or more candidate cells and handover execution conditions (condExecutionCond) corresponding to the one or more candidate cells. Then, the terminal can determine, from the one or more candidate cells, a candidate cell that meets the handover execution condition as a candidate target cell to be switched to. For example, the handover execution condition is to determine whether the signal quality of the candidate cell is higher than the signal quality of the serving cell by a preset offset. Finally, the terminal takes a configuration parameter corresponding to the candidate target cell as a CHO command, access the candidate target cell according to the CHO command, and synchronize with the candidate target cell. For example, the terminal initiates a random access procedure to the candidate target cell and sends an RRCReconfigurationComplete message, etc., so as to realize handover to the candidate target cell. If a candidate cell that meets the handover execution condition is not yet determined among the one or more candidate cells, the terminal continues to maintain an RRC connection with the source base station.

It should be noted that, the CHO can solve the problem that the handover preparation takes too much time and it is too late for the terminal to perform handover. For example, in a high-speed railway scenario, the terminal has a specific motion trajectory, a network device may configure for the terminal, in advance, configuration parameters for the one or more candidate cells and conditions for triggering the terminal to perform handover, and finally, the terminal can initiate an access request to a candidate cell that meets the handover execution condition among the one or more candidate cells.

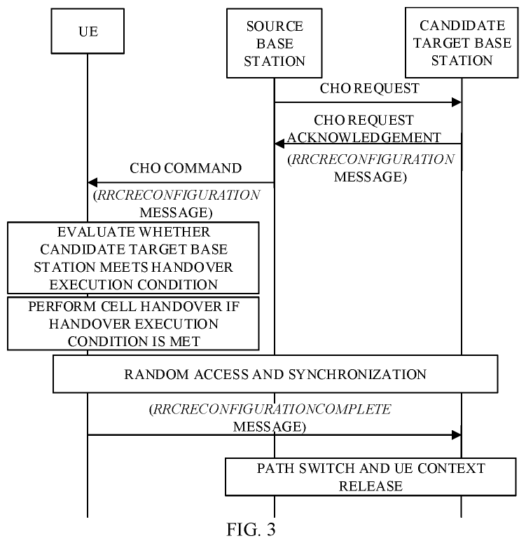

Exemplarily, referring to FIG. 3, the source base station configures for the terminal the configuration parameter for the candidate target cell and the handover execution condition corresponding to the candidate target cell via the CHO command (namely, an RRCReconfiguration message). Then, the terminal evaluates whether the candidate target cell meets the handover execution condition, and in a case where the handover execution condition is met, initiates the random access procedure, and sends the RRCReconfigurationComplete message, etc. so as to perform cell handover. Finally, a (candidate) target base station performs a path switch and notifies the source base station to release UE context, etc.

3. Centralized Unit (CU) and Distributed Unit (DU)

With reference to the above description, a network device in an NR communication system may have different implementation manners. The network device may be an independent node for implementing all functions of a base station, and may also be divided into a CU and a DU. One CU may be connected to multiple DUs. Generally, the CU processes RRC signaling, and the DU processes layer 1 signaling or layer 2 signaling and data. The following takes an NR radio access network (NR-RAN) architecture as an example for description.

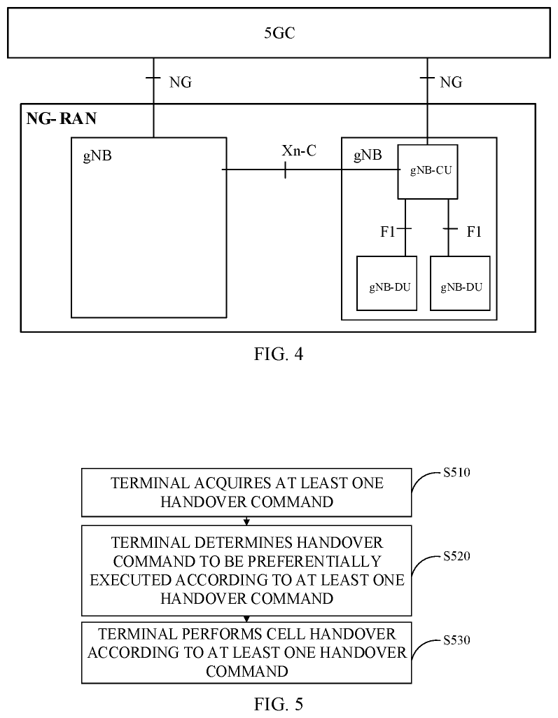

Exemplarily, referring to FIG. 4, an NR-RAN is composed of multiple gNBs that are connected to a 5G core (5GC) network, where the gNBs are connected to one another via an Xn interface, and the gNBs are connected to the 5GC via an NG interface. In addition, a gNB central unit (gNB-CU) is connected to a gNB distributed unit (gNB-DU) via an F1 interface. One gNB may include one gNB-CU and one or more gNB-DUs, and one gNB-DU only can be connected to one gNB-CU. One gNB-CU can be connected to multiple gNB-DUs. The gNB-CU and the gNB-DU are specifically described as follows.

gNB-CU, which is a logical node hosting RRC, SDAP and PDCP protocols of the gNB or RRC and PDCP protocols of the en-gNB, and controls the operation of one or more gNB-DUs.

gNB-DU, which is a logical node hosting RLC, MAC and PHY layers of the gNB or en-gNB, and its operation is partly controlled by gNB-CU, where one gNB-DU supports one or multiple cells, and one cell is supported by only one gNB-DU.

With reference to the above description, a schematic flowchart of a handover processing method is provided in implementations of the disclosure, referring to FIG. 5. The method can be applied to a terminal in a wireless communication system. The method includes the following.

S510, a terminal acquires at least one handover command.

The at least one handover command includes at least one of a first handover command, a second handover command, and a conditional handover (CHO) command, the first handover command is indicated through layer 1 signaling or layer 2 signaling, and the second handover command is indicated through layer 3 signaling;

It should be noted that, the terminal in implementations of the disclosure can access a serving cell to establish an RRC connection and to establish a data radio bearer to carry out service transmission. The serving cell can also configure relevant measurement information for the terminal, so that the terminal measures the serving cell and a neighboring cell, and reports a measurement report, etc. Then, the serving cell can make a handover decision on the basis of the measurement report and some other factors (such as cell load).

However, when the terminal needs to perform cell handover due to factors such as mobility requirements (moving to the edge of the serving cell), load adjustment of wireless transmission service, activation operation and maintenance, network device failure, and cell load of the serving cell, since the network device in implementations of the disclosure uses an radio access network (RAN) architecture where the DU and the CU are separated, the disclosure newly introduces the handover command (namely, the first handover command) triggered by a distributed unit (DU) in a network device (such as a source base station corresponding to the serving cell) and the handover command (namely, the second handover command) triggered by a centralized unit (CU) in the network device in the process of cell handover of the terminal. In addition, it is further considered that there may be a CHO command triggered by the terminal.

On basis of this, in a case where a new handover scheme (the first handover command) is introduced, the terminal may need to handle a scenario where one or more handover commands are triggered simultaneously. That is to say, the terminal may acquire at least one of the first handover command, the second handover command, and the CHO command. Implementations of the disclosure will give a detailed description below regarding how the terminal handles one or more handover commands triggered simultaneously.

Specifically, the first handover command is a handover command triggered by the DU in the network device based on a measurement result of layer 1 or layer 2, and the second handover command is a handover command triggered by the CU in the network device based on a measurement report of layer 3 or cell load.

It should be noted that, since layer 1 (L1) is a physical layer, layer 2 (L2) may include an MAC layer and an RLC layer, and layer 3 (L3) may include an RRC layer, the first handover command in implementations of the disclosure is a handover decision made by the DU in the network device, and the terminal is triggered to perform handover through layer 1 signaling or layer 2 signaling; and the second handover command is a handover decision made by the CU in the network device, and the terminal is triggered to perform handover through layer 3 signaling (for example, RRC signaling). In addition, the first handover command may be used for L1/L2-centric inter-cell mobility, and the second handover command may be indicated through an RRCReconfiguration message.

S520, the terminal determines a handover command to be preferentially executed according to the at least one handover command.

S530, the terminal performs cell handover according to the handover command to be preferentially executed.

As can be seen in implementations of the disclosure, a terminal acquires at least one handover command, determines a handover command to be preferentially executed according to the at least one handover command, and thus performs cell handover according to the handover command to be preferentially executed. Since the at least one handover command includes at least one of a first handover command indicated through layer 1 signaling or layer 2 signaling, a second handover command indicated through layer 3 signaling, and a CHO command, implementations of the disclosure determine the handover command to be preferentially executed from the at least one handover command, and perform cell handover according to the handover command to be preferentially executed so as to implement a handover processing for the at least one handover command, thereby ensuring the continuity and quality of a network service and meeting mobility requirements of the terminal.

It should be noted that, since the terminal may need to handle the at least one handover command triggered simultaneously, in implementations of the disclosure, the handover command to be preferentially executed is determined from the at least one handover command, so that cell handover is performed according to the handover command to be preferentially executed, so as to implement a handover processing procedure for the at least one handover command, thereby ensuring the continuous communication and the quality service, and meeting the mobility requirements of the terminal. Implementations of the disclosure will give a detailed description in combination with different handover commands included in the at least one handover command.

Case 1: for a scenario where a terminal needs to handle a first handover command and a second handover command that are triggered simultaneously, there are the following solutions.

Scheme 1:

In a possible example, if at least one handover command includes the first handover command and the second handover command, determining the handover command to be preferentially executed according to the at least one handover command may include the following steps. The terminal determines one of the at least one handover command as the handover command to be preferentially executed according to a protocol (for example, the protocol specifies that the second handover command is the handover command to be preferentially executed). Or the terminal randomly or automatically selects one of the at least one handover command as the handover command to be preferentially executed. Or the terminal preferentially selects one of the at least one handover command as the handover command to be preferentially executed.

It can be understood that, in a case where the terminal needs to handle the first handover command and the second handover command that are triggered simultaneously, in this example, the handover command to be preferentially executed may be determined from the first handover command and the second handover command according to a specification in a communication protocol developed by the 3GPP, random selection, automatic selection, or preferential selection, or according to other principles. Therefore, a flexible and diversified wireless communication system can be achieved during the process of handling the at least one handover command. For example, the terminal may preferentially select the second handover command to perform cell handover while ignoring the first handover command.

Scheme 2:

In a possible example, if at least one handover command includes the first handover command and the second handover command, determining a handover command to be preferentially executed according to the at least one handover command may include the following steps. The terminal determines the handover command to be preferentially executed according to a handover type of the second handover command, the handover type of the second handover command including one of: inter-frequency handover, intra-frequency handover, and inter-radio access technology handover.

The inter-frequency handover indicates that a downlink frequency-point (a downlink carrier frequency) of a candidate target cell indicated by the second handover command is different from a downlink frequency-point (a downlink carrier frequency) of a serving cell. The intra-frequency handover indicates that the downlink frequency-point of the candidate target cell indicated by the second handover command is the same as the downlink frequency-point of the serving cell. The inter-radio access technology handover indicates that a communication system of the candidate target cell indicated by the second handover command is different from a communication system of the serving cell.

It should be noted that, in a case where the terminal needs to handle the first handover command and the second handover command that are triggered simultaneously, when making a second handover decision, a CU in a network device (such as a source base station corresponding to the serving cell) generally takes into consideration a measurement result reported by the terminal or other factors such as the signal quality of the serving cell and the neighboring cell reported by the terminal, cell load, network mobility requirements, and new service requirements of the terminal, etc. In addition, during the measurement in the connected state, the terminal can perform measurements through different measurement types, such as an intra-frequency measurement, an inter-frequency measurement, and an inter-system measurement. Based on this, in this example, the handover command to be preferentially executed is determined according to different handover types of the second handover command, thereby facilitating analysis of handover requirements and handover efficiency in a handover processing procedure, and ensuring flexibility and diversity of a wireless communication system.

Specifically, determining, according to the handover type of the second handover command, the handover command to be preferentially executed may include the following steps. If the handover type of the second handover command is the inter-frequency handover or the inter-radio access technology handover, the terminal determines the handover command to be preferentially executed as the second handover command. Or if the handover type of the second handover command is the intra-frequency handover, the terminal determines the handover command to be preferentially executed as the first handover command.

It should be noted that, since the CU generally needs to take the measurement result reported by the terminal or other factors into consideration when making the second handover decision, in a case where the handover type of the second handover command is the inter-frequency handover or the inter-radio access technology handover, it is appropriate that the terminal may preferentially execute the second handover command, so as to meet an actual handover requirement. In addition, in a case where the handover type of the second handover command is the intra-frequency handover, the terminal may preferentially execute the first handover command to improve handover efficiency.

Scheme 3:

In a possible example, if at least one handover command includes the first handover command and the second handover command, determining a handover command to be preferentially executed according to the at least one handover command may include the following steps. The terminal determines the handover command to be preferentially executed according to a measurement result of a candidate target cell indicated by the first handover command and a measurement result of a candidate target cell indicated by the second handover command.

The measurement result may include a measurement value of reference signal received power (RSRP), a measurement value of reference signal received quality (RSRQ), a measurement value of signal to interference noise ratio (SINR), channel quality, signal quality, and the like.

It should be noted that, in a case where the terminal needs to handle the first handover command and the second handover command that are triggered simultaneously, if a serving cell is Cell_1, the candidate target cell indicated by the first handover command is Cell_2, and the candidate target cell indicated by the second handover command is Cell_3, the terminal generally performs corresponding measurements on Cell_1 and neighboring cells (including the Cell_2 and the Cell_3) of Cell_1 to report to a network device (for example, a source base station corresponding to the serving cell). Therefore, the terminal can maintain and store the measurement results for Cell_2 and Cell_3. Based on this, in this example, the handover command to be preferentially executed is determined according to the measurement result of the candidate target cell indicated by the first handover command and the measurement result of the candidate target cell indicated by the second handover command, thereby implementing a handover processing procedure for the at least one handover command through comparison of the two measurement results.

Specifically, determining the handover command to be preferentially executed according to the measurement result of the candidate target cell indicated by the first handover command and the measurement result of the candidate target cell indicated by the second handover command may include the following steps. If the signal quality of the candidate target cell indicated by the first handover command is higher than the signal quality of the candidate target cell indicated by the second handover command, the terminal determines the handover command to be preferentially executed as the first handover command. Or if the signal quality of the candidate target cell indicated by the second handover command is higher than the signal quality of the candidate target cell indicated by the first handover command, the terminal determines the handover command to be preferentially executed as the second handover command.

It can be understood that, in this example, it is further considered that the terminal preferentially selects a candidate target cell of better signal quality as a target cell to be switched to so as to execute a corresponding handover command, which is beneficial to ensuring the quality of a network service after handover.

Scheme 4:

In a possible example, if at least one handover command includes the first handover command and the second handover command, determining a handover command to be preferentially executed according to at least one handover command may include the following steps. The terminal determines the handover command to be preferentially executed according to whether a candidate target cell indicated by the first handover command is the same as a candidate target cell indicated by the second handover command.

It should be noted that, in a case where the terminal needs to process the first handover command and the second handover command that are triggered simultaneously, in this example, the handover command to be preferentially executed is determined according to whether the candidate target cell indicated by the first handover command is the same as the candidate target cell indicated by the second handover command. Therefore, a handover processing procedure for the at least one handover command is implemented according to whether the candidate target cell indicated by the first handover command is the same as the candidate target cell indicated by the second handover command, thereby facilitating analysis of the duration of communication interruption, handover requirements, and handover efficiency during the handover processing procedure, and ensuring flexibility and diversity of a wireless communication system.

Specifically, determining the handover command to be preferentially executed according to whether the candidate target cell indicated by the first handover command is the same as the candidate target cell indicated by the second handover command may include the following steps. If the candidate target cell indicated by the first handover command is different from the candidate target cell indicated by the second handover command, the terminal determines the handover command to be preferentially executed is the second handover command. Or if the candidate target cell indicated by the first handover command is the same as the candidate target cell indicated by the second handover command, the terminal determines the handover command to be preferentially executed as the first handover command.

It should be noted that, since the CU generally needs to take the measurement result reported by the terminal or other factors into consideration when making the second handover decision, in a case where the candidate target cell indicated by the second handover command is not the candidate target cell indicated by the first handover command, it is appropriate for the terminal to preferentially execute the second handover command, thereby meeting an actual handover requirement. In addition, in a case where the candidate target cell indicated by the second handover command is the candidate target cell indicated by the first handover command, the terminal may preferentially execute the first handover command to improve the handover efficiency or to reduce the duration of communication interruption during the handover processing procedure.

Case 2: for a scenario where a terminal needs to handle a first handover command and a conditional handover (CHO) command that are triggered simultaneously.

It should be noted that, with reference to the description in the foregoing “CHO Procedure”, an example of how the terminal acquires the CHO command in “Case 2” is given for further description.

In a possible example, if at least one handover command includes the first handover command and the CHO command, acquiring the at least one handover command may include the following steps. The terminal acquires a configuration parameter for at least one candidate cell and a handover execution condition corresponding to the at least one candidate cell from a network device. The terminal determines, from the at least one candidate cell, a candidate cell that meets the corresponding handover execution condition as a candidate target cell to be switched to, where a configuration parameter corresponding to the candidate target cell is the CHO command. The terminal acquires the first handover command from the network device.

It should be noted that, in implementations of the disclosure, the terminal accesses a serving cell to be in a connected state. Then the serving cell finds that the terminal supports the CHO, and pre-configures for the terminal the at least one candidate cell, the configuration parameter for each candidate cell, and the handover execution condition corresponding to each candidate cell. The serving cell can acquire the configuration parameter configured for the terminal by the at least one candidate cell only after negotiation with the at least one candidate cell, and the handover execution condition is determined by the serving cell and then sent to the terminal. Finally, after receiving the configuration parameter for the at least one candidate cell, the terminal starts to evaluate whether the at least one candidate cell meets the handover execution condition. Before any candidate cell meets the handover execution condition, the terminal continues to maintain a connection with the serving cell to perform signaling interaction and data interaction.

Furthermore, it can be understood that, in “Case 2”, a major analysis is made on a scenario where the terminal selects, from the at least one candidate cell configured by the network device, the candidate cell that meets the handover execution condition to trigger a CHO command, and also needs to handle the first handover command triggered by the network device.

The following further describes several schemes for how the terminal determines the handover command to be preferentially executed according to the at least one handover command.

Scheme 1:

In a possible example, determining the handover command to be preferentially executed according to the at least one handover command may include the following steps. The terminal preferentially selects the first handover command as the handover command to be preferentially executed.

It should be noted that, in a case where the terminal needs to handle the first handover command and the CHO command that are triggered simultaneously, since the CHO command is triggered after the terminal evaluates that the at least one candidate cell configured by the network device meets the handover execution condition, and the at least one candidate cell also needs to be pre-configured by the network device, compared with the first handover command triggered in real time by the DU in the network device, the timeliness in triggering of the CHO command may be poor. In order to ensure timely and efficient handover, in this example, the first handover command is preferentially executed.

Scheme 2:

In a possible example, determining, according to the at least one handover command, the handover command to be preferentially executed may include the following steps. The terminal determines, according to a handover type of the CHO command, the handover command to be preferentially executed, where the handover type of the CHO command includes inter-frequency handover or intra-frequency handover.

The inter-frequency handover indicates that a downlink frequency-point (a downlink carrier frequency) of a candidate target cell indicated by the CHO command is different from a downlink frequency-point (a downlink carrier frequency) of the serving cell. The intra-frequency handover indicates that the downlink frequency of the candidate target cell indicated by the CHO command is the same as the downlink frequency-point of the serving cell.

It should be noted that, in a case where the terminal needs to handle the first handover command and the CHO command that are triggered simultaneously, in this example, the handover command to be preferentially executed is determined according to different handover types of the CHO command, thereby facilitating analysis of handover requirements and handover efficiency in a handover processing procedure, and ensuring flexibility and diversity of a wireless communication system.

Specifically, determining, according to the handover type of the CHO command, the handover command to be preferentially executed may include the following steps. If the handover type of the CHO command is the inter-frequency handover, the terminal determines the handover command to be preferentially executed as the CHO command. Or if the handover type of the CHO command is the intra-frequency handover, the terminal determines the handover command to be preferentially executed is the first handover command.

It should be noted that, in a case where the handover type of the CHO command is the inter-frequency handover, it is appropriate that the terminal may preferentially execute the CHO command to meet an actual handover requirement. In addition, in a case where the handover type of the CHO command is the intra-frequency handover, the terminal may preferentially execute the first handover command to improve the handover efficiency.

Scheme 3:

In a possible example, determining the handover command to be preferentially executed according to the at least one handover command may include the following steps. The terminal determines the handover command to be preferentially executed according to a measurement result of the candidate target cell corresponding to the CHO command and a measurement result of the candidate target cell indicated by the first handover command.

The measurement result may include a measurement value of RSRP, a measurement value of RSRQ, a measurement value of SINR, channel quality, signal quality, and the like.

It should be noted that, in a case where the terminal needs to handle the first handover command and the CHO command that are triggered simultaneously, if the serving cell is Cell_1, the candidate target cell indicated by the first handover command is Cell_4, and the candidate target cell indicated by the CHO command is Cell_5, then the terminal generally performs a corresponding measurement on Cell_1 and a neighboring cell (including the Cell_4) of Cell_1 so as to report to the network device (for example, a source base station corresponding to the serving cell), and the terminal performs the corresponding measurement with respect to the at least one candidate cell (including Cell_5) pre-configured by the network device. Therefore, the terminal may store the measurement results for Cell_4 and Cell_5. Based on this, in this example, the handover command to be preferentially executed is determined according to the measurement result of the candidate target cell indicated by the first handover command and the measurement result of the candidate target cell indicated by the CHO command. Therefore, a handover processing procedure for the at least one handover command may be implemented through comparison of the two measurement results.

Specifically, determining the handover command to be preferentially executed according to the measurement result of the candidate target cell corresponding to the CHO command and the measurement result of the candidate target cell indicated by the first handover command may include the following steps. If the signal quality of the candidate target cell indicated by the first handover command is higher than the signal quality of the candidate target cell corresponding to the CHO command, the terminal determines the handover command to be preferentially executed as the first handover command. Or if the signal quality of the candidate target cell corresponding to the CHO command is higher than the signal quality of the candidate target cell indicated by the first handover command, the terminal determines the handover command to be preferentially executed as the CHO command.

It can be understood that, it is further considered in this example that the terminal preferentially selects a candidate target cell of better signal quality as a target cell to be switched to, so as to execute a corresponding handover command, which is beneficial to ensuring the quality of a network service after handover.

Scheme 4:

In a possible example, determining the handover command to be preferentially executed according to the at least one handover command may include the following steps. The terminal determines the handover command to be preferentially executed according to whether a candidate target cell corresponding to the CHO command is the same as a candidate target cell indicated by the first handover command.

It should be noted that, in a case where the terminal needs to handle the first handover command and the second handover command that are triggered simultaneously, in this example, that the handover command to be preferentially executed is determined according to whether the candidate target cell indicated by the first handover command is the same as the candidate target cell indicated by the CHO command. Therefore, a handover processing procedure for the at least one handover command is implemented according to whether the candidate target cell indicated by the first handover command is the same as the candidate target cell indicated by the CHO command, thereby facilitating analysis of handover timeliness and handover efficiency during the handover processing procedure, and ensuring flexibility and diversity of a wireless communication system.

Specifically, determining the handover command to be preferentially executed according to whether the candidate target cell corresponding to the CHO command is the same as the candidate target cell indicated by the first handover command may include the following steps. If the candidate target cell corresponding to the CHO command is different from the candidate target cell indicated by the first handover command, the terminal determines the handover command to be preferentially executed as the CHO command. Or if the candidate target cell corresponding to the CHO command is the same as the candidate target cell indicated by the first handover command, the terminal determines the handover command to be preferentially executed as the first handover command.

It should be noted that, since the terminal generally needs to take into consideration the configuration parameter for the at least one candidate cell configured by the network and the corresponding handover execution condition when triggering the CHO command, in a case where the candidate target cell indicated by the CHO command is not the candidate target cell indicated by the first handover command, it is appropriate for the terminal to preferentially execute the CHO command, thereby meeting an actual handover requirement. In addition, in a case where the candidate target cell indicated by the CHO command is the candidate target cell indicated by the first handover command, the terminal may preferentially execute the first handover command to make handover more timely and efficient.

Case 3: for a scenario where a terminal only needs to handle a triggered first handover command, and a handover execution condition for a conditional handover (CHO) is not yet met.

It should be noted that, in “Case 3”, since the terminal only needs to handle the triggered first handover command, the terminal acquires at least one handover command, which may be understood as the terminal acquiring the first handover command of the network device. In addition, before acquiring the first handover command from a network device, the terminal also acquires relevant configuration information for the CHO from the network device. An example is given below for description.

In a possible example, if the at least one handover command includes the first handover command, before the at least one handover command is acquired, the method further include the following steps. The terminal acquires a configuration parameter for at least one candidate cell and a handover execution condition corresponding to the at least one candidate cell from the network device. Determining a handover command to be preferentially executed according to the at least one handover command include determining, by the terminal, the handover command to be preferentially executed as the first handover command.

It can be understood that, since the terminal only needs to handle the triggered first handover command, and the handover execution condition for the CHO is not yet met, the terminal may preferentially execute the first handover command directly.

Specifically, after cell handover is performed according to the handover command to be preferentially executed, the method further includes the following steps. The terminal retains the configuration parameter for the at least one candidate cell and the handover execution condition corresponding to the at least one candidate cell.

It should be noted that, for a terminal configured with the configuration parameter for the at least one candidate cell and the handover execution condition corresponding to the at least one candidate cell, if the handover execution condition for the CHO is not met but the terminal needs to handle the triggered first handover command, the terminal, after preferentially executing the first handover command, may continue to retain the configuration parameter for the at least one candidate cell configured by the network and the handover execution condition corresponding to the at least one candidate cell, so as to continue to evaluate whether the at least one candidate cell meets the corresponding handover execution condition, and the terminal may execute the CHO when the handover execution condition is met. It can be seen that the terminal continues to retain the configuration parameter for the at least one candidate cell and the handover execution condition corresponding to the at least one candidate cell configured by the network without reconfiguring the CHO by the network, which is beneficial to reducing network signaling overhead.

Further, the method may further include the following steps. If a candidate target cell indicated by the first handover command is a first candidate cell in the at least one candidate cell, the terminal deletes a configuration parameter corresponding to the first candidate cell and a handover execution condition corresponding to the first candidate cell, and retains configuration parameters and handover execution conditions corresponding to remaining candidate cells except the first candidate cell in the at least one candidate cell. Or if the candidate target cell indicated by the first handover command is not in the at least one candidate cell, the terminal retains the configuration parameter for at least one candidate target cell and the handover execution condition corresponding to the at least one candidate cell.

It can be understood that, in a case where the configuration parameter for the at least one candidate cell and the handover execution condition corresponding to the at least one candidate cell configured by the network are continuously retained, it is further considered in this example whether the candidate target cell indicated by the first handover command is in the at least one candidate cell configured by the network. If the candidate target cell indicated by the first handover command is in the at least one candidate cell, that is, the candidate target cell indicated by the first handover command is the first candidate cell in the at least one candidate cell, the terminal needs to delete the configuration parameter corresponding to the first candidate cell from the configuration parameter of the at least one candidate cell while retaining the remaining configuration parameters, and delete the handover execution condition corresponding to the first candidate cell from the handover execution condition corresponding to the at least one candidate cell while retaining the remaining handover execution conditions. Therefore, the stability of the subsequent CHO execution is ensured.

For example, if the candidate target cell indicated by the first handover command is Cell_7, and candidate cells configured for the CHO by the network are {Cell_7, Cell_8, Cell_9}, the terminal, after executing the first handover command to access Cell_7, deletes a configuration parameter and a handover execution condition corresponding to Cell_7, retains a configuration parameter and a handover execution condition corresponding to Cell_8, and retains a configuration parameter and a handover execution condition corresponding to Cell_9. Therefore, the terminal may continue to evaluate whether the candidate cell meets the handover execution condition, and may perform the CHO when the candidate cell meets the handover execution condition, thereby reducing network signaling overhead.

Specifically, performing cell handover according to the handover command to be preferentially executed may include the following steps. The terminal suspends evaluation of whether the at least one candidate cell meets the corresponding handover execution condition. The terminal performs cell handover according to the first handover command, and after performing cell handover according to the first handover command, continues to evaluate whether the at least one candidate cell meets the corresponding handover execution condition.

It should be noted that, for the terminal configured with the configuration parameter for the at least one candidate cell and the handover execution condition corresponding to the at least one candidate cell, if the handover execution condition for the CHO is not yet met when the terminal receives the first handover command from the network device, the terminal may notify a RRC layer via a PHY layer or a MAC layer that the terminal will suspend evaluation of whether the at least one candidate cell meets the corresponding handover execution condition, and after executing the first handover command (namely, after handover completion), continues to evaluate whether the at least one candidate cell meets the corresponding handover execution condition. Therefore, there is no need for the network to reconfigure for the CHO, which is beneficial to reducing network signaling overhead.

It can be seen that, in implementations of the disclosure, the terminal acquires the at least one handover command, determines the handover command to be preferentially executed according to the at least one handover command, and thus performs cell handover according to the handover command to be preferentially executed. Since the at least one handover command includes at least one of a first handover command indicated through layer 1 signaling or layer 2 signaling, a second handover command indicated through layer 3 signaling, and a CHO command, therefore, in implementations of the disclosure, the handover command to be preferentially executed is determined from the at least one handover command and cell handover is performed according to the handover command to be preferentially executed, so as to implement a handover processing procedure for the at least one handover command. Therefore, the continuity and quality of the network service are ensured, and the mobility requirements of the terminal are met.

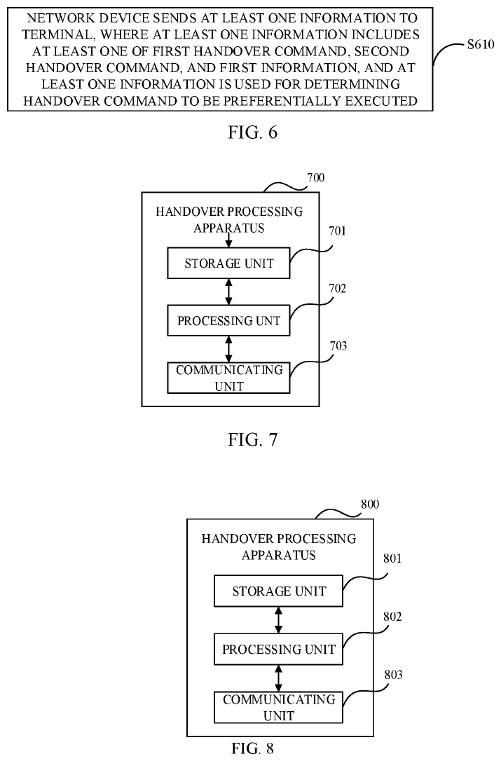

Consistent with the foregoing implementations, implementations of the disclosure provide a schematic flowchart of another handover processing method, referring to FIG. 6. The handover processing method can be applied to a network device in a wireless communication system. The method includes the following.

S610, a network device sends at least one information to a terminal, where the at least one information includes at least one of a first handover command, a second handover command, and first information, and the at least one information is used for determining a handover command to be preferentially executed.

The first information includes a configuration parameter for at least one candidate cell and a handover execution condition corresponding to the at least one candidate cell.

The first handover command is indicated through layer 1 signaling or layer 2 signaling, and the second handover command is indicated through layer 3 signaling.

It should be noted that, the terminal in implementations of the disclosure may access a serving cell to establish an RRC connection and to establish a data radio bearer to carry out service transmission. Simultaneously, the serving cell can configure relevant measurement information for the terminal, so that the terminal measures a neighboring cell and the serving cell, and reports a measurement report. The serving cell may then make a handover decision based on the measurement report as well as some other factors (such as cell load), etc.

However, when the terminal needs to perform cell handover due to factors such as mobility requirements (moving to the edge of the serving cell), load adjustment of wireless transmission service, activation operation and maintenance, network device failure, and cell load of the serving cell, since the network device in implementations of the disclosure uses an RAN architecture where the DU and the CU are separated, the disclosure newly introduces the handover command (namely, the first handover command) triggered by a distributed unit (DU) in a network device (such as a source base station corresponding to the serving cell) and the handover command (namely, the second handover command) triggered by a centralized unit (CU) in the network device in the process of cell handover of the terminal. In addition, since the network device further needs to configure for the terminal the configuration information and the corresponding handover execution condition of the at least one candidate cell for the CHO, there may be the CHO command triggered by the terminal.

On basis of this, in a case where a new handover scheme (the first handover command) is introduced, the terminal may need to handle a scenario where one or more handover commands are triggered simultaneously. That is to say, the terminal may acquire at least one of the first handover command, the second handover command, and the CHO command.

Specifically, the first handover command is the handover command triggered by the DU in the network device based on a measurement result of layer 1 or layer 2, and the second handover command is the handover command triggered by the CU in the network device based on a measurement report of layer 3 or cell load.

It should be noted that, since layer 1 (L1) is a PHY layer, layer 2 (L2) may include an MAC layer and an RLC layer, and layer 3 (L3) may include an RRC layer, the first handover command in implementations of the disclosure is a handover decision made by the DU in the network device, and the terminal is triggered to perform handover through layer 1 signaling or layer 2 signaling; and the second handover command is a handover decision made by the CU in the network device, and the terminal is triggered to perform handover through layer 3 signaling (for example, RRC signaling).

In a possible example, before or when triggering handover, the CU in the network device or the DU in the network device communicates with each other to avoid sending the first handover command and the second handover command simultaneously.

It can be understood that, after the CU needs to trigger the second handover command or has triggered the second handover command, the CU notifies the DU that the CU itself will trigger the second handover command or has triggered the second handover command, so as to temporarily prevent the DU from triggering the first handover command.

It can be further understood that, since the network device in implementations of the disclosure may use the RAN architecture where the CU and the DU are separated, when making a handover decision for the second handover command (or before triggering the second handover command), the CU may notify the DU that the second handover command is to be triggered or has been triggered, thereby preventing the DU from triggering the first handover command again. Similarly, when making a handover decision for the first handover command (or before triggering the second handover), the DU may notify the CU that the first handover command is to be triggered or has been triggered, thereby preventing the CU from triggering the second handover decision again. Based on this, the terminal only can receive the first handover command or the second handover command, which is beneficial to preventing the terminal from handling both the first handover command and the second handover command.

In a possible example, the CU in the network device takes the first handover command being sent by the DU in the network device into consideration when making the handover decision for the second handover command, and takes a candidate target cell indicated by the first handover command as a criterion for triggering handover.

It can be understood that, since the network device in implementations of the disclosure may use the RAN architecture where the CU and the DU are separated, when making the handover decision for the second handover command, the CU may take the first handover command being sent by the DU into consideration and take the candidate target cell indicated by the first handover command as a criterion for triggering handover. That is to say, if the terminal is switched from a serving cell to a target cell after executing the first handover command, the CU takes the target cell as a criterion for triggering handover (for example, performing measurement reporting for the target cell). Based on this, the terminal only can receive the first handover command, which is beneficial to preventing the terminal from handling both the first handover command and the second handover command.

In a possible example, the DU in the network device takes the second handover command being sent by the CU in the network device into consideration when making the handover decision for the first handover command, and takes a candidate target cell indicated by the second handover command as a criterion for triggering handover.

It can be understood that, since the network device in implementations of the disclosure may use the RAN architecture where the CU and the DU are separated, when the DU makes the handover decision for the first handover command, the DU may take the second handover command being triggered by the CU into consideration, and take a candidate target cell indicated by the second handover command as a criterion for triggering handover. That is to say, if the terminal is switched from the serving cell to the target cell after executing the second handover command, the DU takes the target cell as a criterion for triggering handover. Based on this, the terminal only can receive the second handover command, which is beneficial to preventing the terminal from handling both the first handover command and the second handover command.

It can be seen that, in implementations of the disclosure, the network device sends the at least one information to the terminal, where the at least one information includes at least one of the first handover command, the second handover command, and the first information. Since the at least one information is used for determining the handover command to be preferentially executed, the first information includes a configuration parameter for the at least one candidate cell and a handover execution condition corresponding to the at least one candidate cell, the first handover command is indicated through layer 1 signaling or layer 2 signaling, and the second handover command is indicated through layer 3 signaling, therefore, in implementations of the disclosure, the handover command to be preferentially executed is determined from the at least one handover command and cell handover is performed according to the handover command to be preferentially executed, so as to implement a handover processing procedure for the at least one handover command. Therefore, the continuity and quality of the network service are ensured, and the mobility requirements of the terminal are met.

As above mentioned, the solutions of implementations of the disclosure are mainly described from a perspective of the method. It can be understood that, in order to implement the foregoing functions, the terminal or the network device includes a hardware structure and/or a software module corresponding to each function. The person skilled in the art should be easily aware that, with reference to units and methods of each example described in implementations of the disclosure, the disclosure can be implemented in the form of hardware or in combination of hardware and computer software. Whether a specific function is implemented in the form of hardware or in the form of hardware driven by a computer software depends on specific applications and design constraints of the technical solutions. The person skilled in the art can use different methods to implement the described functions for each specific application, but such implementation shall not be considered as going beyond the scope of the disclosure.

The implementations of the disclosure can divide functional units of the terminal or the network device according to the foregoing examples of methods. For example, each functional unit may be divided to correspond to each function, or two or more functions may also be integrated into one processing unit. The integrated unit may be implemented in the form of hardware, and may also be implemented in the form of a software program module. It should be noted that, the division of units in implementations of the disclosure is schematic and is only a logical division of functions, and there may be other division modes in actual implementation.

In a case where an integrated unit is applied, FIG. 7 provides a block diagram of functional units of a handover processing apparatus. The handover processing apparatus 700 is applied to the terminal, specifically including a processing unit 702 and a communicating unit 703. The processing unit 702 is configured to control and manage an action of the terminal. For example, the processing unit 702 is configured to support the terminal executing the steps in FIG. 5 and other procedures for the technical solutions described in the disclosure. The communicating unit 703 is configured to support communication between the terminal and other devices in a wireless communication system. The handover processing apparatus 700 may further include a storage unit 701 that is configured to store program codes and data of the terminal.

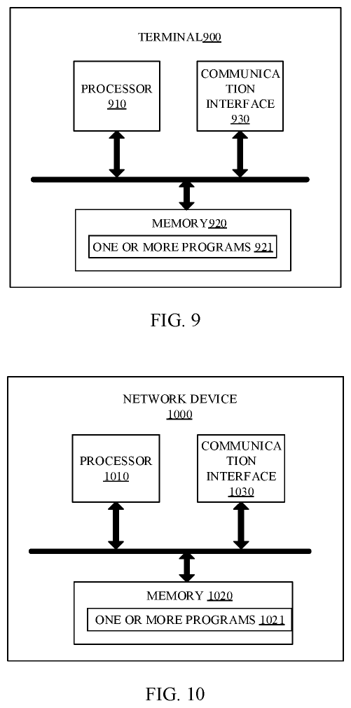

The processing unit 702 may be a processor or a controller, and may be, for example, a central processing unit (CPU), a general-purpose processor, a digital signal processor (DSP), an application-specific integrated circuit (ASIC), a field programmable gate array (FPGA) or other programmable logic devices, a transistor logic device, a hardware component, or any arbitrary combination. The processing unit 702 may implement or perform various illustrative logical blocks, modules, and circuits described in connection with the disclosure. The processing unit 702 may also be a combination that implements a computing function, for example, a combination that includes one or more microprocessors, a combination of a DSP and a microprocessor, and the like. The communicating unit 703 may be a communication interface, a transceiver, a transceiver circuit, or the like, and the storage unit 701 may be a memory. When the processing unit 702 is a processor, the communicating unit 703 is a communication interface, and the storage unit 701 is a memory, the handover processing apparatus 700 involved in implementations of the disclosure may be the terminal illustrated in FIG. 9.

In a specific implementation, the processing unit 702 is configured to executing any step executed by the terminal in the foregoing method implementations, and when data transmission such as sending is executed, the communicating unit 703 is optionally invoked to complete the corresponding operation. The following will give a detailed description.

The processing unit 702 is configured to: acquiring at least one handover command, where the at least one handover command includes at least one of a first handover command, a second handover command, and a CHO command, the first handover command is indicated through layer 1 signaling or layer 2 signaling, and the second handover command is indicated through layer 3 signaling; determining a handover command to be preferentially executed according to the at least one handover command; and performing cell handover according to the handover command to be preferentially executed.

It should be noted that, a specific implementation of each operation in implementations described in FIG. 7 can refer to descriptions in the method implementations illustrated in FIG. 5 or FIG. 6 above, which will not be described here.

It can be seen that, in implementations of the disclosure, the at least one handover command is acquired, the handover command to be preferentially executed is determined according to at least one handover command, and thus cell handover is performed according to the handover command to be preferentially executed. Since the at least one handover command includes at least one of the first handover command indicated through layer 1 signaling or layer 2 signaling, the second handover command indicated through layer 3 signaling, and the CHO command, therefore, in implementations of the disclosure, the handover command to be preferentially executed is determined from the at least one handover command and cell handover is performed according to the handover command to be preferentially executed, so as to implement a handover processing procedure for the at least one handover command, thereby ensuring the continuity and quality of a network service and meeting the mobility requirements of the terminal.

In a possible example, the first handover command is a handover command triggered by a DU in a network device based on a measurement result of layer 1 or layer 2. The second handover command is a handover command triggered by a CU in the network device based on a measurement report of layer 3 or cell load.

In a possible example, if the at least one handover command includes the first handover command and the second handover command, in terms of determining the handover command to be preferentially executed according to the at least one handover command, the processing unit 702 is specifically configured to perform: determining one of the at least one handover command as the handover command to be preferentially executed according to a protocol, selecting randomly or automatically one of the at least one handover command as the handover command to be preferentially executed, or selecting preferentially one of the at least one handover command as the handover command to be preferentially executed.

In a possible example, if the at least one handover command includes the first handover command and the second handover command, in terms of determining the handover command to be preferentially executed according to the at least one handover command, the processing unit 702 is specifically configured to perform: determining the handover command to be preferentially executed according to a handover type of the second handover command, where the handover type of the second handover command include one of inter-frequency handover, intra-frequency handover, or inter-radio access technology handover.

In a possible example, in terms of determining the handover command to be preferentially executed according to the handover type of the second handover command, the processing unit 702 is specifically configured to perform: determining the handover command to be preferentially executed as the second handover command when the handover type of the second handover command is the inter-frequency handover or the inter-radio access technology handover; and determining the handover command to be preferentially executed as the first handover command when the handover type of the second handover command is the intra-frequency handover.

In a possible example, if the at least one handover command includes the first handover command and the second handover command, in terms of determining the handover command to be preferentially executed according to the at least one handover command, the processing unit 702 is specifically configured to perform: determining the handover command to be preferentially executed according to a measurement result of a candidate target cell indicated by the first handover command and a measurement result of a candidate target cell indicated by the second handover command.

In a possible example, in terms of determining the handover command to be preferentially executed according to the measurement result of the candidate target cell indicated by the first handover command and the measurement result of the candidate target cell indicated by the second handover command, the processing unit 702 is specifically configured to perform: determining the handover command to be preferentially executed as the first handover command when the signal quality of the candidate target cell indicated by the first handover command is higher than the signal quality of the candidate target cell indicated by the second handover command; or determining the handover command to be preferentially executed as the second handover command when the signal quality of the candidate target cell indicated by the second handover command is higher than the signal quality of the candidate target cell indicated by the first handover command.

In a possible example, if the at least one handover command includes the first handover command and the second handover command, in terms of determining the handover command to be preferentially executed according to the at least one handover command, the processing unit 702 is specifically configured to perform: determining the handover command to be preferentially executed according to whether a candidate target cell indicated by the first handover command is the same as a candidate target cell indicated by the second handover command.

In a possible example, in terms of determining the handover command to be preferentially executed according to whether the candidate target cell indicated by the first handover command is the same as the candidate target cell indicated by the second handover command, the processing unit 702 is specifically configured to perform: determining the handover command to be preferentially executed as the second handover command when the candidate target cell indicated by the first handover command is different from the candidate target cell indicated by the second handover command; and for determining the handover command to be preferentially executed as the first handover command when the candidate target cell indicated by the first handover command is the same as the candidate target cell indicated by the second handover command.

In a possible example, if the at least one of the handover commands includes the first handover command and the CHO command, in terms of acquiring the at least one handover command, the processing unit 702 is specifically configured to perform: acquiring a configuration parameter for at least one candidate cell and a handover execution condition corresponding to the at least one candidate cell from a network device; determining, from the at least one candidate cell, a candidate cell that meets the handover execution condition as a candidate target cell to be switched to, where a configuration parameter corresponding to the candidate target cell is the CHO command; and acquiring the first handover command from the network device.

In a possible example, in terms of determining the handover command to be preferentially executed according to the at least one handover command, the processing unit 702 is specifically configured to perform: selecting preferentially the first handover command as the handover command to be preferentially executed.

In a possible example, in terms of determining the handover command to be preferentially executed according to the at least one handover command, the processing unit 702 is specifically configured to perform: determining the handover command to be preferentially executed according to a handover type of the CHO command, where the handover type of the CHO command includes inter-frequency handover or intra-frequency handover.

In a possible example, in terms of determining the handover command to be preferentially executed according to the handover type of the CHO command, the processing unit 702 is specifically configured to perform: determining the handover command to be preferentially executed as the CHO command when the handover type of the CHO command is the inter-frequency handover; and determining the handover command to be preferentially executed as the first handover command when the handover type of the CHO command is the intra-frequency handover.

In a possible example, in terms of determining the handover command to be preferentially executed according to the at least one handover command, the processing unit 702 is specifically configured to perform: determining the handover command to be preferentially executed according to a measurement result of the candidate target cell corresponding to the CHO command and a measurement result of a candidate target cell indicated by the first handover command.

In a possible example, in terms of determining the handover command to be preferentially executed according to the measurement result of the candidate target cell corresponding to the CHO command and the measurement result of the candidate target cell indicated by the first handover command, the processing unit 702 is specifically configured to perform: determining the handover command to be preferentially executed as the first handover command when the signal quality of the candidate target cell indicated by the first handover command is higher than the signal quality of the candidate target cell corresponding to the CHO command; and determining the handover command to be preferentially executed as the CHO command when the signal quality of the candidate target cell corresponding to the CHO command is higher than the signal quality of the candidate target cell indicated by the first handover command.

In a possible example, in terms of determining the handover command to be preferentially executed according to the at least one handover command, the processing unit 702 is specifically configured to perform: determining the handover command to be preferentially executed according to whether the candidate target cell corresponding to the CHO command is the same as a candidate target cell indicated by the first handover command.

In a possible example, in terms of determining the handover command to be preferentially executed according to whether the candidate target cell corresponding to the CHO command is the same as the candidate target cell indicated by the first handover command, the processing unit 702 is specifically configured to perform: determining the handover command to be preferentially executed as the CHO command when the candidate target cell corresponding to the CHO command is different from the candidate target cell indicated by the first handover command; or determining the handover command to be preferentially executed as the first handover command when the candidate target cell corresponding to the CHO command is the same as the candidate target cell indicated by the first handover command.

In a possible example, if the at least one handover command includes the first handover command, in terms of acquiring the at least one handover command, the processing unit 702 is further used for: acquiring a configuration parameter for at least one candidate cell and a handover execution condition corresponding to the at least one candidate cell from a network device; and determining the handover command to be preferentially executed as the first handover command in terms of determining the handover command to be preferentially executed according to the at least one handover command.

In a possible example, after performing cell handover according to the handover command to be preferentially executed, the processing unit 702 is further used for: retaining the configuration parameter for the at least one candidate cell and the handover execution condition corresponding to the at least one candidate cell.

In a possible example, the processing unit 702 is further used for: deleting a configuration parameter corresponding to a first candidate cell and a handover execution condition corresponding to the first candidate cell, and retaining configuration parameters and handover execution conditions corresponding to remaining candidate cells except the first candidate cell in the at least one candidate cell, when a candidate target cell indicated by a first handover command is the first candidate cell in the at least one candidate cell; or retaining a configuration parameter for the at least one candidate target cell and the handover execution condition corresponding to the at least one candidate cell, when the candidate target cell indicated by the first handover command is not in the at least one candidate cell.

In a possible example, in terms of performing cell handover according to the handover command to be preferentially executed, the processing unit 702 is specifically configured to perform: suspending evaluation of whether the at least one candidate cell meets the corresponding handover execution condition; and performing cell handover according to the first handover command, and after performing cell handover according to the first handover command, continuing to evaluate whether the at least one candidate cell meets the corresponding handover execution condition.

In a case where the integrated unit is applied, FIG. 8 provides a block diagram of functional units of another handover processing apparatus. The handover processing apparatus 800 is applied to a network device, specifically including a processing unit 802 and a communicating unit 803. The processing unit 802 is configured to control and manage an action of the network device. For example, the processing unit 802 is configured to support the network device executing steps in FIG. 6 and other procedures for the technical solutions described in the disclosure. The communicating unit 803 is configured to support communication between the network device and other devices in a wireless communication system. The handover processing apparatus 800 may further include a storage unit 801 that is configured to store program codes and data of the network device.

The processing unit 802 may be a processor or a controller, and may be, for example, a CPU, a DSP, an ASIC, a FPGA or other programmable logic devices, a transistor logic device, a hardware component, or any arbitrary combination. The processing unit 802 may implement or perform various illustrative logical blocks, modules, and circuits described in connection with the disclosure. The processing unit 802 may also be a combination that implements a computing function, for example, a combination that includes one or more microprocessors, a combination of a DSP and a microprocessor, and the like. The communicating unit 803 may be a communication interface, a transceiver, a transceiver circuit, or the like, and the storage unit 801 may be a memory. When the processing unit 802 is a processor, the communicating unit 703 is a communication interface, and the storage unit 701 is a memory, the handover processing apparatus 800 involved in implementations of the disclosure may be the network device illustrated in FIG. 10.

In a specific implementation, the processing unit 802 is configured to execute any step executed by the network device in the foregoing method implementations, and when data transmission such as sending is executed, the communicating unit 803 is optionally invoked to complete the corresponding operation. The following will give a detailed description.

The processing unit 802 is configured to send at least one information to a terminal, the at least one information including at least one of a first handover command, a second handover command, and first information, and the at least one information being used for determining a handover command to be preferentially executed, where the first information includes a configuration parameter for at least one candidate cell and a handover execution condition corresponding to the at least one candidate cell, the first handover command is indicated through layer 1 signaling or layer 2 signaling, and the second handover command is indicated through layer 3 signaling.

It should be noted that, a specific implementation of each operation in implementations described in FIG. 8 can refer to descriptions in the method implementations illustrated in FIG. 5 or FIG. 6 above, which will not be described here.

It can be seen that, in implementations of the disclosure, the at least one information is sent to the terminal, where the at least one information includes at least one of the first handover command, the second handover command, and the first information. Since the at least one information is used for determining the handover command to be preferentially executed, the first information includes the configuration parameter for the at least one candidate cell and the handover execution condition corresponding to the at least one candidate cell, the first handover command is indicated through layer 1 signaling or layer 2 signaling, and the second handover command is indicated through layer 3 signaling. Therefore, it is considered in implementations of the disclosure that the handover command to be preferentially executed is determined from the at least one handover command and that cell handover is performed according to the handover command to be preferentially executed, so as to implement a handover processing procedure for the at least one handover command, thereby ensuring the continuity and quality of a network service and meeting the mobility requirements of the terminal.

In a possible example, the first handover command is a handover command triggered by a DU in the network device based on a measurement result of layer 1 or layer 2. The second handover command is a handover command triggered by a CU in the network device based on a measurement report of layer 3 or cell load.

In a possible example, before or when triggering handover, a CU in a network device or a DU in the network device communicates with each other to avoid sending the first handover command and the second handover command simultaneously.

In a possible example, a CU in a network device takes the first handover command being triggered by a DU in the network device into consideration when making a handover decision for the second handover command, and takes a candidate target cell indicated by the first handover command as a criterion for triggering handover.

Referring to FIG. 9, FIG. 9 is a schematic structural diagram of a terminal provided in implementations of the disclosure. The terminal 900 includes a processor 910, a memory 920, a communication interface 930, and a communication bus for connecting the processor 910, the memory 920, and the communication interface 930.

The memory 920 is, including but not limited to, a random access memory (RAM), a read-only memory (ROM), an erasable programmable read-only memory (EPROM), or a compact disc read-only memory (CD-ROM). The memory 920 is used for relevant instructions and data.

The communication interface 930 is configured to receive and transmit data.

The processor 910 may be one or more CPUs, and in a case where the processor 910 is a CPU, the CPU may be a single-core CPU or a multi-core CPU.

The processor 910 in the terminal 900 is configured to read one or more programs 921 stored in the memory 920. The following operations are performed: acquiring at least one handover command, where the at least one handover command includes at least one of a first handover command, a second handover command, and a CHO command, the first handover command is indicated through layer 1 signaling or layer 2 signaling, and the second handover command is indicated through layer 3 signaling; determining the handover command to be preferentially executed according to the at least one handover command; and performing cell handover according to the handover command to be preferentially executed.

It should be noted that, a specific implementation of each operation can refer to corresponding descriptions in the method implementations illustrated in FIG. 5 or FIG. 6 above, and the terminal 900 can be configured to perform the method related to the terminal in the above method implementations of the disclosure, which will not be described here.

It can be seen that, the terminal acquires at least one handover command, determines the handover command to be preferentially executed according to the at least one handover command, and performs cell handover according to the handover command to be preferentially executed. Since the at least one handover command includes at least one of a first handover command indicated through layer 1 signaling or layer 2 signaling, a second handover command indicated through layer 3 signaling, and a CHO command, it is considered in implementations of the disclosure that the handover command to be preferentially executed is determined from the at least one handover command and that cell handover is performed according to the handover command to be preferentially executed, so as to implement a handover processing procedure for the at least one handover command, thereby ensuring the continuity and quality of a network service and meeting the mobility requirements of the terminal.

Referring to FIG. 10, FIG. 10 is a schematic structural diagram of a network device provided in implementations of the disclosure. The network device 1000 includes a processor 1010, a memory 1020, a communication interface 1030, and a communication bus for connecting the processor 1010, the memory 1020, and the communication interface 1030.

The memory 1020 is, including but not limited to, an RAM, an ROM, an EPROM, or a CD-ROM. The memory 1020 is configured to store relevant instructions and data.

The communication interface 1030 is configured to receive and transmit data.

The processor 1010 may be one or more CPUs, and in a case where the processor 1010 is a CPU, the CPU may be a single-core CPU or a multi-core CPU.

The processor 1010 in the network device 1000 is configured to read one or more programs 1021 stored in the memory 1020, so as to execute the following steps: sending at least one information to the terminal, the at least one information including at least one of a first handover command, a second handover command, and first information, the at least one information being used for determining the handover command to be preferentially executed, where the first information includes a configuration parameter for at least one candidate cell and a handover execution condition corresponding to the at least one candidate cell, the first handover command is indicated through layer 1 signaling or layer 2 signaling, and the second handover command is indicated through layer 3 signaling.

It should be noted that, a specific implementation of each operation can refer to corresponding descriptions in the method implementations illustrated in FIG. 5 or FIG. 6 above, and the network device 1000 can be configured to perform the method related to the network device in the above method implementations of the disclosure, which will not be described here.

It can be seen that, the network device sends at least one information to the terminal, where the at least one information includes at least one of a first handover command, a second handover command, and first information. Since the at least one information is used for determining the handover command to be preferentially executed, the first information includes a configuration parameter for at least one candidate cell and a handover execution condition corresponding to the at least one candidate cell, the first handover command is indicated through layer 1 signaling or layer 2 signaling, and the second handover command is indicated through layer 3 signaling, it is considered in implementations of the disclosure that the handover command to be preferentially executed is determined from the at least one handover command and that cell handover is performed according to the handover command to be preferentially executed, so as implement a handover processing procedure for the at least one handover command, thereby ensuring the continuity and quality of a network service and meeting the mobility requirements of the terminal.

A chip is provided in implementations of the disclosure. The chip includes a processor. The processor is configured to invoke and execute the computer programs stored in a memory, to cause a device equipped with the chip to execute part or all of steps described in the terminal or the management device of the forgoing method implementations.

A computer-readable storage medium is provided in implementations of the disclosure. The computer-readable storage medium is configured to store a computer program for electronic data interchange (EDI), where the computer program enables a computer to execute part or all of steps described in the terminal or the management device of the forgoing method implementations.

A computer program product is further provided in implementations of the disclosure. The computer program product includes a computer program. The computer program is operable to enable a computer to execute part or all of steps described in the terminal or the management device of the forgoing method implementations. The computer program product may be a software installer.

The steps of the method or the algorithm described in implementations of the disclosure may be implemented in a form of hardware or in the way that a processor executes software instructions. The software instructions may be composed of corresponding software modules, which may be stored in an RAM, a flash memory, an ROM, an erasable programmable ROM (EPROM), an electrically EPROM, a register, a hard disk, a mobile hard disk, a CD-ROM, or any other form of storage medium known in the art. An illustrative storage medium is coupled to the processor, so that the processor can read information from the storage medium and write information to the storage medium. It is certain that the storage medium may also be part of the processor. The processor and the storage medium may be in an ASIC. In addition, the ASIC may be in a terminal or a management device. It is certain that the processor and the storage medium may be in the terminal or the management device as a discrete component.

The persons skilled in the art should be aware that, in the above one or more examples, the functions described in implementations of the disclosure may be implemented in whole or in part, via software, hardware, firmware, or any of the combination. When being implemented via software, the functions may be implemented in whole or in part in a form of a computer program product. The computer program product includes one or more computer instructions. When the computer program instructions are loaded and executed on the computer, the procedures or functions described in implementations of the disclosure are generated in whole or in part. The computer may be a general-purpose computer, a special-purpose computer, a computer network, or other programmable devices. The computer instructions may be stored in a computer-readable storage medium or transmitted from one computer-readable storage medium to another computer-readable storage medium. For example, the computer instructions can be sent from a website, a computer, a server, or a data center to another website, computer, server, or data center via a cable (for example, a coaxial cable, an optical fiber, and a digital subscriber line (DSL)) transmission or a wireless (for example, infrared, wireless, and microwave) transmission. The computer-readable storage medium may be any available medium that the computer can access or may be a data storage device, such as a server, data center, which includes one or more available integrated media. The available medium may be a magnetic medium (for example, a floppy disk, a hard disk, and a tape), an optical medium (for example, digital video disc (DVD)), or a semiconductor medium (for example, a solid state disk (SSD)).

The foregoing specific implementations further elaborate the purpose, technical solutions, and beneficial effects of implementations of the disclosure. It should be understood that, while the disclosure has been described in connection with above embodiments, the disclosure is not to be limited to the disclosed embodiments but, on the contrary, is intended to cover any modifications, equivalent arrangements, and improvements included within the scope of the appended claims, which scope is to be accorded the broadest interpretation so as to encompass all such modifications and equivalent structures as is permitted under the law.

1. A handover processing method, comprising:
acquiring, by a terminal, at least one handover command, the at least one handover command comprising at least one of a first handover command, a second handover command, and a conditional handover (CHO) command, the first handover command being indicated through layer 1 signaling or layer 2 signaling, and the second handover command being indicated through layer 3 signaling;
determining, by the terminal, a handover command to be preferentially executed according to the at least one handover command; and
performing, by the terminal, cell handover according to the handover command to be preferentially executed.

2. The method of claim 1, wherein
the first handover command is a handover command triggered by a distributed unit (DU) in a network device based on a measurement result of layer 1 or layer 2; and
the second handover command is a handover command triggered by a centralized unit (CU) in the network device based on a measurement report of layer 3 or cell load.

3. The method of claim 1, wherein when the at least one handover command comprises the first handover command and the second handover command, determining the handover command to be preferentially executed according to the at least one handover command comprises:
determining, by the terminal, one of the at least one handover command as the handover command to be preferentially executed according to a protocol; or
selecting randomly or automatically, by the terminal, one of the at least one handover command as the handover command to be preferentially executed; or
selecting preferentially, by the terminal, one of the at least one handover command as the handover command to be preferentially executed.

4. The method of claim 1, wherein when the at least one handover command comprises the first handover command and the second handover command, determining the handover command to be preferentially executed according to the at least one handover command comprises:
determining, by the terminal, according to a handover type of the second handover command, the handover command to be preferentially executed, the handover type of the second handover command comprising one of: inter-frequency handover, intra-frequency handover, or inter-radio access technology handover.

5. The method of claim 4, wherein determining the handover command to be preferentially executed according to the handover type of the second handover command comprises:
determining, by the terminal, the handover command to be preferentially executed as the second handover command, when the handover type of the second handover command is the inter-frequency handover or the inter-radio access technology handover; or
determining, by the terminal, the handover command to be preferentially executed as the first handover command, when the handover type of the second handover command is the intra-frequency handover.

6. The method of claim 1, wherein when the at least one handover command comprises the first handover command and the second handover command, determining the handover command to be preferentially executed according to the at least one handover command comprises:
determining, by the terminal, the handover command to be preferentially executed according to a measurement result of a candidate target cell indicated by the first handover command and a measurement result of a candidate target cell indicated by the second handover command.

7. The method of claim 6, wherein determining the handover command to be preferentially executed according to the measurement result of the candidate target cell indicated by the first handover command and the measurement result of the candidate target cell indicated by the second handover command comprises:
determining, by the terminal, the handover command to be preferentially executed as the first handover command, when the signal quality of the candidate target cell indicated by the first handover command is higher than the signal quality of the candidate target cell indicated by the second handover command; or
determining, by the terminal, the handover command to be preferentially executed as the second handover command, when the signal quality of the candidate target cell indicated by the second handover command is higher than the signal quality of the candidate target cell indicated by the first handover command.

8. The method of claim 1, wherein when the at least one handover command comprises the first handover command and the second handover command, determining the handover command to be preferentially executed according to the at least one handover command comprises:
determining, by the terminal, the handover command to be preferentially executed according to whether a candidate target cell indicated by the first handover command is the same as a candidate target cell indicated by the second handover command.

9. The method of claim 8, wherein determining the handover command to be preferentially executed according to whether the candidate target cell indicated by the first handover command is the same as the candidate target cell indicated by the second handover command comprises:
determining, by the terminal, the handover command to be preferentially executed as the second handover command, when the candidate target cell indicated by the first handover command is different from the candidate target cell indicated by the second handover command; or
determining, by the terminal, the handover command to be preferentially executed as the first handover command, when the candidate target cell indicated by the first handover command is the same as the candidate target cell indicated by the second handover command.

10. The method of claim 1, wherein when the at least one handover command comprises the first handover command and the CHO command, acquiring the at least one handover command comprises:
acquiring, by the terminal, a configuration parameter for at least one candidate cell and a handover execution condition corresponding to the at least one candidate cell from a network device; and
determining from the at least one candidate cell, by the terminal, a candidate cell that meets the handover execution condition as a candidate target cell to be switched to, wherein a configuration parameter corresponding to the candidate target cell is the CHO command; and
acquiring, by the terminal, the first handover command from the network device.

11. The method of claim 10, wherein determining the handover command to be preferentially executed according to the at least one handover command comprises:
selecting preferentially, by the terminal, the first handover command as the handover command to be preferentially executed.

12. The method of claim 10, wherein determining the handover command to be preferentially executed according to the at least one handover command comprises:
determining, by the terminal, the handover command to be preferentially executed according to a handover type of the CHO command, wherein the handover type of the CHO command comprises inter-frequency handover or intra-frequency handover.

13-25. (canceled)

26. A terminal, comprising a comprising a processor, a memory, a communication interface, and one or more programs stored in the memory, wherein the processor is configured to execute the one or more programs to:
acquire, through the communication interface, at least one handover command, the at least one handover command comprising at least one of a first handover command, a second handover command, and a conditional handover (CHO) command, the first handover command being indicated through layer 1 signaling or layer 2 signaling, and the second handover command being indicated through layer 3 signaling;
determine a handover command to be preferentially executed according to the at least one handover command; and
perform cell handover according to the handover command to be preferentially executed.

27. The terminal of claim 26, wherein
the first handover command is a handover command triggered by a distributed unit (DU) in a network device based on a measurement result of layer 1 or layer 2; and
the second handover command is a handover command triggered by a centralized unit (CU) in the network device based on a measurement report of layer 3 or cell load.

28. The terminal of claim 26, wherein when the at least one handover command comprises the first handover command and the second handover command, the processing unit is configured to:
determine one of the at least one handover command as the handover command to be preferentially executed according to a protocol; or
select randomly or automatically one of the at least one handover command as the handover command to be preferentially executed; or
select preferentially one of the at least one handover command as the handover command to be preferentially executed.

29. The terminal of claim 26, wherein when the at least one handover command comprises the first handover command and the second handover command, the processing unit is configured to:
determine the handover command to be preferentially executed according to a handover type of the second handover command, wherein the handover type of the second handover command comprises one of: inter-frequency handover, intra-frequency handover, or inter-radio access technology handover.

30. The terminal of claim 29, wherein the processing unit is configured to:
determine the handover command to be preferentially executed as the second handover command, when the handover type of the second handover command is the inter-frequency handover or the inter-radio access technology handover; or
determine the handover command to be preferentially executed as the first handover command, when the handover type of the second handover command is the intra-frequency handover.

31. The terminal of claim 26, wherein when the at least one handover command comprises the first handover command and the second handover command, the processing unit is configured to:
determine the handover command to be preferentially executed according to a measurement result of a candidate target cell indicated by the first handover command and a measurement result of a candidate target cell indicated by the second handover command.

32. The terminal of claim 31, wherein the processing unit is configured to:
determine the handover command to be preferentially executed as the first handover command, when the signal quality of the candidate target cell indicated by the first handover command is higher than the signal quality of the candidate target cell indicated by the second handover command; or
determine the handover command to be preferentially executed as the second handover command, when the signal quality of the candidate target cell indicated by the second handover command is higher than the signal quality of the candidate target cell indicated by the first handover command.

33-52. (canceled)

53. A non-transitory computer-readable storage medium configured to store a computer program for electronic data interchange (EDI), wherein the computer program enables a computer to perform:
acquiring, by the computer, at least one handover command, the at least one handover command comprising at least one of a first handover command, a second handover command, and a conditional handover (CHO) command, the first handover command being indicated through layer 1 signaling or layer 2 signaling, and the second handover command being indicated through layer 3 signaling;
determining, by the computer, a handover command to be preferentially executed according to the at least one handover command; and
performing, by the computer, cell handover according to the handover command to be preferentially executed.

54. (canceled)
